(19) United States
(12) Patent Application Publication
(10) Pub. No.: US 2002/0104388 A1
(43) Pub. Date: Aug. 8, 2002

(54) Apparatus for sensing torque between mechanical members

(76) Inventor: Carl D. Schrubbe, Waukesha, WI (US)

Correspondence Address: QUARLES & BRADY LLP, 411 E. WISCONSIN AVENUE, SUITE 2040, MILWAUKEE, WI, 53202-4497, US

(21) Appl. No.: 09/776,215

(22) Filed: Feb. 2, 2001

(51) Int. Cl. G01L 3/02

(52) U.S. Cl. 73/862.328

(57) ABSTRACT

An apparatus for sensing torque between mechanical members that are connected by a circular member, the circular member having a center hub, a first annular section disposed about the center hub and having a first element, and a second annular section disposed about the first annular section and having a second element. Relative rotation occurs between the first and second annular sections in proportion to torsional forces exerted between the mechanical members. As the circular member rotates, first and second sensors produce output signals as the elements pass the sensors, whereupon a detector circuit connected to the sensors detects the phase relationship between the first and second signals. That phase relationship indicates the torque applied between the mechanical members.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

1. Field of the Invention

The present invention relates to motorized actuators, such as of a type used to operate valves and airflow dampers in a heating, ventilation, and air conditioning (HVAC) system, and more particularly, to an apparatus for real-time torque sensing between first and second mechanical members.

2. Description of Related Art

Motorized actuators are commonly used to open and close valves and dampers in HVAC systems. Oftentimes, these motorized actuators contain an electric motor that is connected by a gear train to an output coupling that controls the various loads placed thereupon. The gear train allows the low torque electric motor to operate relatively large loads whereby the motor is operated to place the valves and dampers into any of a number of positions between an extreme open and an extreme closed position.

A problem common to motorized actuators is their inability to sense the torque applied between first and second mechanical members such as the other gears within the gear train. While sophisticated gear trains can achieve gear ratios of 25,000:1, the potential for adversely transmitting the torque between the first and second mechanical members is significant. At a minimum, the torque will dampen the effectiveness of the gear train; more significantly, continued torque can cause serious and extensive mechanical damage to the gear train, actuator, and entire HVAC system.

Therefore it is desirable to provide a simplified, yet accurate apparatus for sensing torque between first and second mechanical members such as the gears of a gear train.

### SUMMARY OF THE INVENTION

By this invention, the torque between first and second mechanical members is sensed by sensing the relative rotation between a first and second annular section of a circular member such as a gear. Such an invention finds particular utility in the motorized actuators of the type commonly employed to operate HVAC and other types of systems.

A preferred embodiment of the invention comprises a circular member that has a center hub, a first annular section disposed about the center hub and having a first element, the first annular section being coupled to the first mechanical member, and a second annular section disposed about the first annular section and having a second element, the second annular section being coupled to the second mechanical member. By this arrangement, relative rotation occurs between the first and second annular sections in proportion to torsional forces exerted between the first and second mechanical members. More specifically, a first sensor produces a first signal when the first element passes near the first sensor as the circular member rotates, and a second sensor produces a second signal when the second element passes near the second sensor as the circular member rotates. Then, a detector circuit that is connected to the sensors detects a phase relationship between the first and second signals.

In a preferred embodiment, the first and second elements are separate parts of a single radial aperture that passes through the circular member. In another embodiment, the first and second elements are separate parts of separate radial apertures that pass through the circular member. In yet another embodiment, the first and second elements are separate parts of a single radial groove that is formed on a surface of the circular member. In still yet another embodiment, the first and second elements are separate parts of separate radial grooves that are formed on a surface of the circular member. In these embodiments, the first and second sensors may each comprise a light emitter and light detector. These light emitters and light detectors may be placed on the same side, or on a different side, of the circular member, as appropriate.

In another alternative embodiment, the first and second elements may be first and second magnets and the first and second sensors may be first and second Hall effect sensors. In addition, an annular resilient section can be used to separate the first and second annular sections of the circular member, and the circular member may comprise a wheel, gear, or otherwise.

The objects, advantages, and aspects of the present invention will become apparent from the following description. In the description, reference is made to the accompanying drawings, which form a part hereof, and in which there is shown, by way of illustration, preferred embodiments of the present invention. Such embodiments do not necessarily represent the full scope of the invention, however, and reference must also be made to the claims herein for properly interpreting the scope of this invention.

### BRIEF DESCRIPTION OF THE DRAWINGS

FIG. 1 is an isometric view of an actuator in accordance with the inventive arrangements of the present invention;

FIG. 2 is a top view of a circular member according to the present invention, showing no relative rotation between a first and second annular section of the circular member;

FIG. 3 is a cross-sectional view of the circular member of FIG. 2, taken along line 3-3 of FIG. 2;

FIG. 4 is a graphical depiction of first and second output signals as respective first and second elements pass respective first and second sensors as the circular member of FIG. 2 rotates;

FIG. 5 is a top view of the circular member of FIG. 2 showing relative rotation between the first and second annular sections of the circular member;

FIG. 6 is a cross-sectional view of the circular member of FIG. 5, taken along line 6-6 of FIG. 5;

FIG. 7 is a graphical depiction of first and second output signals as respective first and second elements pass respective first and second sensors as the circular member of FIG. 5 rotates;

FIG. 8 is an alternative embodiment of the present invention wherein the first and second elements are separate parts of separate apertures passing through the circular member;

FIG. 9 is an alternative embodiment of the present invention wherein an annular resilient section separates the first and second annular sections of the circular member of FIG. 8;

FIG. 10 is a cross-sectional view of an alternative circular member wherein the first and second elements are separate parts of a single radial groove formed on a surface of the circular member, and wherein the light emitters and light detectors are on a same side of the circular member;

FIG. 11 is a cross-sectional view of an alternative circular member wherein the first and second elements are separate parts of separate radial grooves formed on a surface of the circular member, and wherein the light emitters and light detectors are on a same side of the circular member; and

FIG. 12 is a cross-sectional view of an alternative circular member wherein the first and second elements are radially disposed first and second magnets formed on a surface of the circular member, and wherein the first and second sensors are respective first and second Hall effect senors.

### DETAILED DESCRIPTION OF THE INVENTION

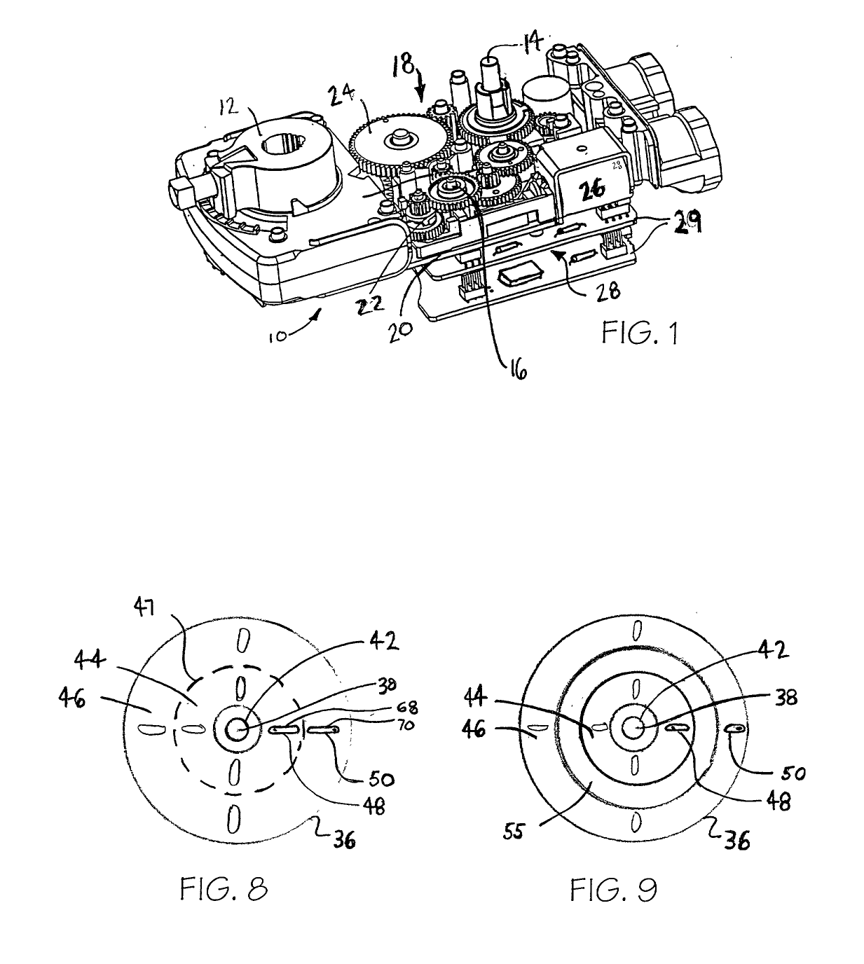

With initial reference to FIG. 1, an actuator 10 comprises an output coupling 12 through which a shaft of a device, such as a damper or airflow valve (not shown), can be inserted for operation thereof by the actuator 10. The output coupling 12 preferably turns through approximately 90° to operate the connected device, although other angles of rotation can, of course, also be provided for. A coiled spring (not shown) and electric motor (not shown) are commonly mounted on respective shafts 14,16 for connection to the output coupling 12 by a gear train 18 that is supported by a support plate 20. The gear train 18 functions as a transmission that transfers rotational force from the shafts 14,16 to the output coupling 12. As known, the gear train 18 contains a clutch 22 that engages an output gear 24 that is connected to the shaft 16 of the motor. The clutch 22 is operated by a solenoid 26 that, when electrically powered, causes the clutch 22 to engage and mechanically couple the shaft 16 to the remaining stages of the gear train 18. A spring carried within the solenoid 26 disengages the clutch 22 when the solenoid 26 is de-energized.

The depicted gear train 18 has approximately eight stages between the shaft 16 and output coupling 12. It is comprised of a plurality of gears that are mounted on pins extending from the support plate 20. For example, one gear is coupled to the spring of the solenoid 26 while another engages the output gear 24 that is coupled to the output coupling 12. One of the gears of this gear train 18 can be configured to sense the torque between the gears that surround it in accordance with the inventive arrangements of the present invention. In further accord with the inventive arrangements, a control circuit 28 can be carried on printed circuit boards 29 that are attached beneath the support plate 20 in the orientation of the actuator 10.

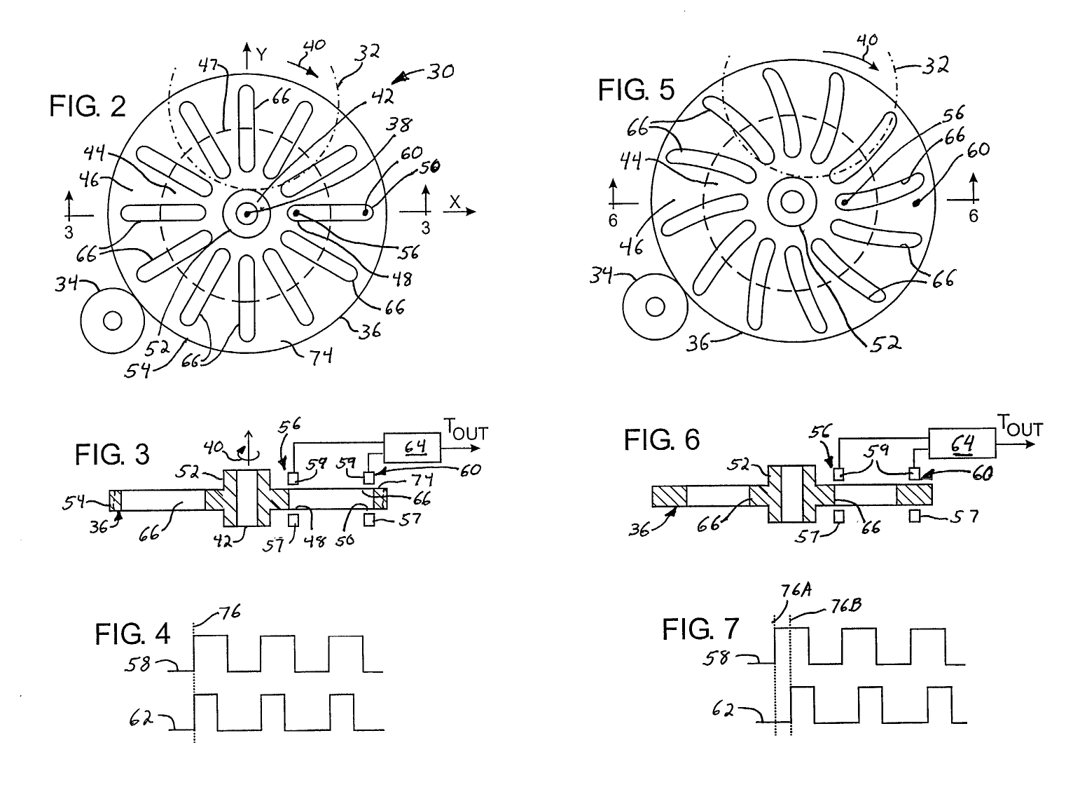

With reference now to FIGS. 2 and 5, an apparatus 30 for sensing torque between a first mechanical member 32 (show in phantom) and a second mechanical member 34 is shown. The apparatus 30 comprises a circular member 36 for rotation in an x-y plane about a z-axis of rotation that is orthogonal to the x-y plane and passes through a center 38 of the circular member 36. For discussion purposes, it is hereby assumed that the circular member 36 rotates in the x-y plane about the z-axis according to the direction of rotation shown by the arrow 40, although rotation in the opposite direction is also permitted.

The first and second mechanical members 32,34 can be first and second gears of a gear train whereupon the circular member 36 is a sensing gear placed there between for the purposes of transferring rotational power and sensing the torque between the first and second mechanical members 32,34. The relative sizes of the first mechanical member 32, second mechanical member 34, and circular member 36 are depicted as representative sizes only. Although gears are illustrated, the first and second mechanical members 32,34 can each comprise a belt, rope, chain, shaft, wheel, gear, or other mechanical component that can be coupled to the circular member 36. In addition, the circular member 36 can comprise a wheel, gear, pulley, sprocket, or other circular component.

The circular member 36 has a center hub 42 that is uniformly disposed about its center 38 for attachment to a mounting pin or other fastener. In addition, the circular member 36 includes a first annular section 44 that is disposed about the center hub 42 and a second annular section 46 that is disposed about the first annular section 44. A plurality of apertures 66 extend radially through the circular member 36 and have end portions that form first and second elements 48,50. The first and second annular sections 44,46 are shown separated by a dashed line 47 in the figures whereupon the first annular section 44 is mechanically coupled to the first mechanical member 32 and the second annular section 46 is mechanically coupled to the second mechanical member 34. Because the second annular section 46 is disposed about the first annular section 44 and each has there within its respective element, the first and second elements 48,50 are disposed at different distances from the center 38, and the first element 48 is disposed closer to the center hub 42 than the second element 50. In addition, although only four apertures 66 are shown in FIG. 2, either additional or fewer apertures may be provided in order to provide the necessary sensing capabilities of the apparatus 30. By providing additional or fewer apertures 66, more or less relative rotation between the first and second annular sections 44,46 can be provided and sensed, as desired.

In a preferred embodiment, a peripheral section of the center hub 42 may comprise a toothed surface 52 for the coupling thereof to the first mechanical member 32. Similarly, a peripheral section of the second annular section 46 may also comprise a toothed surface 54 for the coupling thereof to the second mechanical member 34.

Because the first mechanical member 32 is coupled to the first annular section 44 and the second mechanical member 34 is coupled to the second annular section 46, relative rotation occurs between the first annular section 44 and second annular section 46 in proportion to torsional forces exerted between the first and second mechanical members 32,34. For example, when greater torque is applied between the first and second mechanical members 32,34, the relative rotation between the first and second annular sections 44,46 is increased.

In order to accomplish sensing of the relative rotation between the first and second annular sections 44,46 of the circular member 36, the apparatus 30 includes a first sensor 56 that is disposed near a rotational path of the first element 48 to produce a first signal 58 when the first element 48 passes near the first sensor 56 as the first annular section 44 rotates about the z-axis. Similarly, a second sensor 60 is disposed near a rotational path of the second element 50 to produce a second signal 62 when the second element 50 passes near the second sensor 60 as the second annular section 46 rotates about the z-axis. These first and second sensors 56,60 are shown in cross-sectional views of the apparatus 30 of FIGS. 3 and 6, and they do not impede movement of the circular member 36.

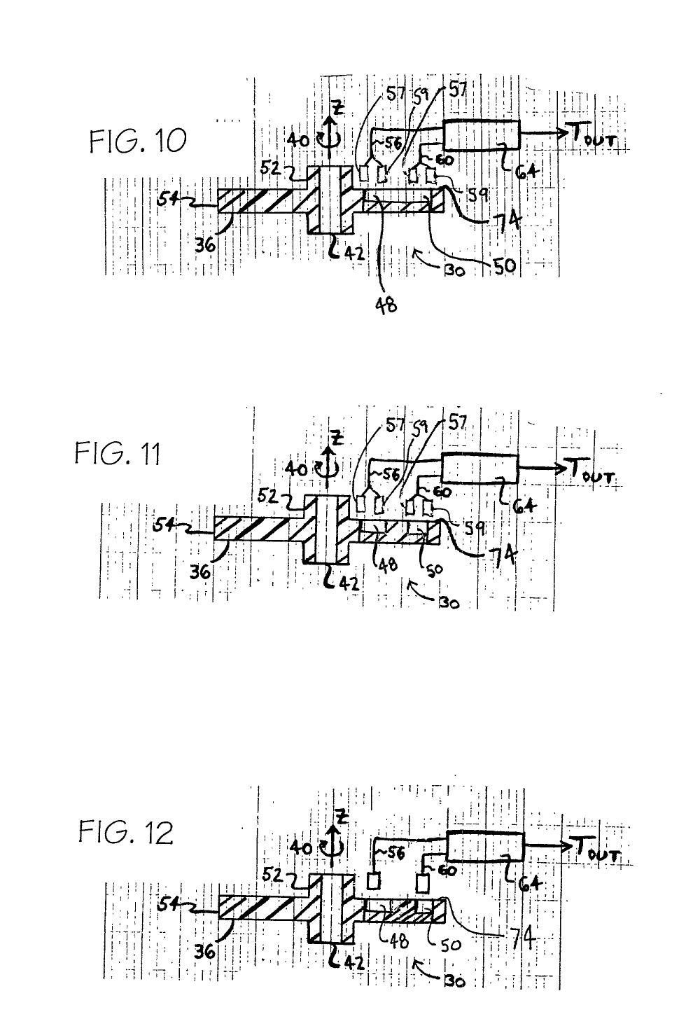

In the preferred embodiment, the first and second sensors 56,60 each comprise a light emitter 57 and a light detector 59 that are arranged to detect light that is either transmitted through the circular member 36 or reflected thereabout by the circular member 36. In the embodiment wherein light is transmitted through the circular member 36 by way of the aperture 66 passing there through, it is preferred to position the light emitter 57 and light detector 59 on opposite sides of the circular member 36, as shown in FIGS. 3 and 6. In the embodiment wherein light is reflected about the circular member 36, as will elaborated upon below, it is preferred to position the light emitter 57 and light detector 59 on a same side of the circular member, as shown in FIGS. 10-11.

The first and second signals 58,62 respectively associated with the first and second sensors 56,60 of FIGS. 3 and 6 are shown in FIGS. 4 and 7. These first and second signals 58,62 are compared by a detector circuit 64 that is part of the control circuit 28 of FIG. 1. This detector circuit 64 can be microprocessor-based and carry therein a conventional signal processor for detecting phase relationships between the first and second signals 58,62.

Referring specifically to FIG. 2, in which a low-torque condition is depicted, there is no relative rotation between the first and second annular sections 44,46 of the circular member 36 because no torsional force is being exerted between the first and second mechanical members 32,34. However, as the circular member 36 rotates in the direction of rotation 40, measurable and predictable slippage occurs between the first and second annular sections 44,46.

Regardless of the direction of rotation 40, the first element 48 leads the second element 50 as torque builds across the first and second annular sections 44,46 of the circular member 36. As a result, the second element 50 time-lags behind the first element 48 when torque occurs between the first and second mechanical members 32,34, as shown in an exaggerated fashion by the apertures 66 of FIG. 5.

As shown in FIGS. 2 and 5, the first and second elements 48,50 can be separate parts of a single aperture 66 passing through the circular member 36. As such, the aperture 66 can comprise a slit, slot, spoke, or other geometrically shaped aperture formed in the circular member 36 for a particular torque assessment. Preferably, this aperture 66 is disposed substantially along a radius of the circular member 36 under the no-torque condition. In an alternative embodiment, the first element 48 can be a part of a first aperture 68 passing through the circular member 36 and the second element 50 can be a part of a second aperture 70 passing through the circular member 36, as shown in FIG. 8. Again, these first and second apertures 68,70 are preferably disposed along a common radius of the circular member 36 under the no-torque condition. In such an embodiment, the relative rotation between the first and second annular sections 44,46 can be enhanced by incorporating an annular resilient section 55 there between, as shown in the circular member 36 of FIG. 9. In this embodiment, the annular resilient section 55 is preferably a rubberized channel that separates the first and second annular sections 44,46.

In yet another embodiment, the first and second elements 48,50 can be separate parts of a single groove formed on a surface 74 of the circular member 36, and under the no-torque condition, this groove is preferably disposed along a radius of the circular member 36. Such an embodiment is depicted in FIG. 10. Alternatively, the first element 48 can be part of a first groove that is formed on the surface 74 of the circular member 36 and the second element 50 can be part of a second groove that is formed on the same surface 74 of the circular member 36, the first and second grooves being preferably disposed along a common radius of the circular member 36 under the no-torque condition. Such an embodiment is depicted in FIG. 11.

Whether the first and second elements 48,50 are parts of separate slits, slots, spokes, grooves, or otherwise, they are preferably disposed substantially along a common radius of the circular member 36 under the no-torque condition. Then, when a torque condition between the first and second mechanical members 32,34 exists, the first and second elements 48,50 are forced out of their radial alignment. Alternatively, the first and second elements 48,50 can be disposed along different radii of the circular member 36 under the no-torque condition. Then, when a torque condition between the first and second mechanical members 32,34 exists, the first and second elements 48,50 can be either forced into substantial radial alignment or into a further exaggeration of their radial displacements, as appropriate for a given application. The detector circuit 64 can be programmed to accommodate these different configurations by techniques well-known in the art.

In addition, although only a single pair of first and second elements 48,50 have been primarily described, a plurality of first and second elements 48,50 can be formed by a plurality of apertures 66, as shown in FIGS. 2 and 5. For example, a more torque-sensitive apparatus 30 may need to be able to detect a torque condition sooner than a less torque-sensitive apparatus 30, whereby additional apertures 66 forming additional pairs of first and second elements 48,50 can be formed in the circular member 36. Furthermore, the actual shape and placement of the apertures 66 and first and second elements 48,50 there within are preferably chosen to reflect the desired characteristics of the desired apparatus 30. The common element of the chosen number and shape of apertures 66 is that the first and second elements 48,50 are allowed to angularly deform relative to one another, the amount of angular deformation being relative to the amount of torque between the first and second mechanical members 32,34. This angular deformation is sensed by the phase relationship between the first and second elements 48,50, as detected by the first and second sensors 56,60 that operate independently of one another and are disposed proximal to the rotational paths of the respective first and second elements 48,50.

For example, in the condition depicted in FIGS. 2-4, the leading edges 76 of the first and second signals 58,62 are in phase because the first and second elements 48,50 pass the respective first and second sensors 56,60 at substantially the same time. Thus, the conclusion can be drawn by the detector circuit 64 that no torsional force is being exerted between the first and second mechanical members 32,34. On the other hand, in the condition depicted in FIGS. 5-7, the leading edges 76 of the first and second signals 58,62 are out of phase because the first and second elements 48,50 pass the respective first and second sensors 56,60 at measurably different times. Thus, the conclusion can be drawn by the detector circuit 64 that a torsional force is being exerted between the first and second mechanical members 32,34. As the torque between the first and second mechanical members 32,34 increases, so too does the torque between the first and second annular sections 44,46. Consequently, the detector circuit 64 detects an increasingly different phase relationship between the leading edges 76 of the first and second signals 58,62, whereby the phase relationships between the leading edges 76 of the first and second signals 58,62 correspond to the actual transmitted torque between the first and second mechanical members 32,34.

The phase relationship between the first and second signals 58,62 is proportional to the torque exerted on the circular member 36. Thus, the magnitude of the phase relationship can be used to control the motor of the actuator 10. For example, the motor can be turned off in order to avoid damage thereto when the torque exceeds a given value, as specified by a pre-defined phase relationship.

In addition, the detector circuit 64 can preferably produce a torque indicating output signal (Tₒᵤₜ) that is responsive to the phase relationship between the first and second signals 58,62 by techniques known in the art. For example, the detector circuit 64 can actuate an alarm if a change in the phase relationship exceeds a pre-defined value.

If and when a torque condition is detected between the first and second mechanical elements 32,34, the direction of rotation 40 of the circular member 36 can be temporarily suspended or reversed in order to alleviate the torque condition. For example, the motor of the actuator 10 can be stopped and later restarted.

Dependant upon the type, shape, and number of pairs of first and second elements 48,50 chosen for a particular application, different types, shapes, and numbers of first and second sensors 56,60 can be employed. For example, Hall effect sensors can be used to produce an electric signal in response to the movement of a magnet. Thus, if the first element 48 is a first magnet and the second element 50 is a second magnet, the first and second sensors 56,60 could be a first and second Hall effect sensors, as shown in FIG. 12. Preferably, the first and second magnets would be flush with a first surface 74 of the circular member 36, as shown. These arrangements, and others of course, allow the detector circuit 64 to be connected to the first and second sensors 56,60 in order to detect the phase relationship between the first and second respective signals 58,62.

The spirit of the present invention is not limited to the embodiments described above. Rather, the details and features of exemplary embodiments were disclosed as required. Without departing from the scope of this invention, other modifications should therefore remain apparent to those skilled in the art. Thus, it must be understood that the detailed description of the invention and drawings were intended as illustrative only, and not by way of limitation.

To apprize the public of the scope of this invention, the following claims are made:

What is claimed is:

1. An apparatus for sensing torque between a first mechanical member and a second mechanical member, the apparatus comprising:
a circular member having a first annular section and a second annular section disposed about the first annular section, the first annular section including a first element and being engaged by the first mechanical member, the second annular section including a second element and being engaged by the second mechanical member, wherein relative rotation between the first annular section and the second annular section occurs in response to torsional force exerted between the first mechanical member and the second mechanical member;
a first sensor which produces a first signal when the first element passes the first sensor as the circular member rotates;
a second sensor which produces a second signal when the second element passes the second sensor as the circular member rotates; and
a detector circuit connected to the first sensor and to the second sensor to detect a phase relationship between the first signal and the second signal.

2. The apparatus as recited in claim 1 wherein the first element and the second element are disposed at different distances from a center of the circular member.

3. The apparatus as recited in claim 1 wherein the first element and the second element are formed by different sections of an aperture in the circular member.

4. The apparatus as recited in claim 3 wherein the aperture is elongated with a longitudinal axis that extends radially in the circular member.

5. The apparatus as recited in claim 1 wherein the first element is a first aperture in the circular member and the second element is a second aperture in the circular member.

6. The apparatus as recited in claim 5 wherein the first aperture and the second aperture are disposed along a common radial line extending from a center of the circular member.

7. The apparatus as recited in claim 1 wherein the first element and the second element are formed by an elongated groove formed on a surface of the circular member.

8. The apparatus as recited in claim 7 wherein the elongated groove has a longitudinal axis that extends radially on the surface of the circular member.

9. The apparatus as recited in claim 1 wherein the first element is a first groove in the circular member and the second element is a second groove in the circular member.

10. The apparatus as recited in claim 9 wherein the first groove and the second groove are disposed along a common radial line extending from a center of the circular member.

11. The apparatus as recited in claim 1 wherein the first element is a magnet and the first sensor is a Hall effect sensor.

12. The apparatus as recited in claim 1 wherein the second element is a magnet and the second sensor is a Hall effect sensor.

13. The apparatus as recited in claim 1 wherein the first sensor comprises a light emitter and a light detector.

14. The apparatus as recited in claim 1 wherein the second sensor comprises a light emitter and a light detector.

15. The apparatus as recited in claim 1 wherein an annular resilient section separates the first annular section and the second annular section.

16. The apparatus as recited in claim 1 wherein the detector circuit produces a torque magnitude indication in response to the phase relationship between the first signal and the second signal.

17. The apparatus as recited in claim 1 wherein the second annular section has a circumferential surface which is engaged by the second mechanical member.

18. The apparatus as recited in claim 1 wherein at least one of the first annular section and the second annular section has a circumferential surface with gear teeth.

19. The apparatus as recited in claim 1 wherein the first annular section is coupled to a hub the has a toothed surface which is engaged by the first mechanical member.

20. An actuator comprising:
a) a motor connected to a rotatable shaft;
b) an output coupling to connect a load to the actuator; and
c) a gear train coupling the shaft to the output coupling, the gear train having sensing gear with a first annular section and a second annular section disposed about the first annular section, one of the first annular section and a second annular section being connected to the motor and the other of the first annular section and a second annular section being connected to the output coupling, first annular section including a first element and the second annular section including a second element, wherein relative rotation between the first annular section and the second annular section occurs in response to torsional force exerted between the motor and the output coupling;
a first sensor which produces a first signal when the first element passes the first sensor as the sensing gear rotates;
a second sensor which produces a second signal when the second element passes the second sensor as the sensing gear rotates; and
a detector circuit connected to the first sensor and to the second sensor to sense a phase relationship between the first signal and the second signal.
